(19) United States
(12) Patent Application Publication
(10) Pub. No.: US 2025/0016808 A1
(43) Pub. Date: Jan. 9, 2025

(54) System and Method for Dynamic Policy Generation in Near-Real Time (RT) Radio Access Network Intelligent Controller (RIC) for Adaptive Applications

(71) Applicant: Nokia Technologies Oy, Espoo (FI)

(72) Inventors: Edward GRINSHPUN, Freehold, NJ (US); Alistair URIE, Issy Ies Moulineaux (FR); Jozsef ZOPCSAK, Munich (DE)

(21) Appl. No.: 18/291,307

(22) PCT Filed: Jul. 29, 2022
(86) PCT No.: PCT/US2022/038783

§ 371 Date: Jan. 23, 2024

Related U.S. Application Data
(60) Provisional application No. 63/227,113, filed on Jul. 29, 2021.

(51) Int. Cl. H04W 72/51; H04W 24/02; H04W 28/24

(52) U.S. Cl. CPC H04W 72/51; H04W 24/02; H04W 28/24

(57) ABSTRACT

Systems, methods, apparatuses, and computer program products for cell re-selection are provided. One method may include obtaining, by a near-real-time radio access node intelligent controller (near RT-RIC), at least one tier 1 policy. The near-RT RIC may obtain layer 2 (L2) metadata from at least one E2 node, and application types run by user equipment served by the at least one E2 node. The near-RT RIC may compute at least one optimized per user equipment guidance policy. The near-RT RIC may transmit the at least one computed optimized per user equipment guidance policy to the at least one E2 node.

### CROSS-REFERENCE TO RELATED APPLICATION

This application is related to and claims the priority of U.S. Provisional Patent Application No. 63/227,113, filed Jul. 29, 2021, the entirety of which is hereby incorporated herein by reference.

### TECHNICAL FIELD

Some example embodiments may generally relate to mobile or wireless telecommunication systems, such as Long Term Evolution (LTE), fifth generation (5G) radio access technology (RAT), new radio (NR) access technology, and/or other communications systems. For example, certain example embodiments may relate to systems and/or methods for dynamic policy generation.

### BACKGROUND

Examples of mobile or wireless telecommunication systems may include 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine type communication (mMTC). NR is expected to deliver extreme broadband, ultra-robust, low latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some embodiments, a method may include obtaining, by a near-real-time radio access node intelligent controller (RT-RIC), at least one tier 1 policy. The method may further include obtaining, by the near-RT RIC, layer 2 (L2) metadata from at least one E2 node. The method may further include obtaining, by the near-RT RIC, application types run by user equipment served by the at least one E2 node. The method may further include computing, by the near-RT RIC, at least one optimized per user equipment guidance policy. The method may further include transmitting, by the near-RT RIC, the at least one computed optimized per user equipment guidance policy to the at least one E2 node.

In accordance with certain embodiments, an apparatus may include means for obtaining at least one tier 1 policy. The apparatus may further include means for obtaining layer 2 (L2) metadata from at least one E2 node. The apparatus may further include means for obtaining application types run by user equipment served by the at least one E2 node. The apparatus may further include means for computing at least one optimized per user equipment guidance policy. The apparatus may further include means for transmitting the at least one computed optimized per user equipment guidance policy to the at least one E2 node.

In accordance with various embodiments, an apparatus may include at least one processor and at least one memory including computer program code. The at least one memory and the computer program code may be configured to, with the at least one processor, cause the apparatus to at least obtain at least one tier 1 policy. The at least one memory and the computer program code may be further configured to, with the at least one processor, cause the apparatus to at least obtain layer 2 (L2) metadata from at least one E2 node. The at least one memory and the computer program code may be further configured to, with the at least one processor, cause the apparatus to at least obtain application types run by user equipment served by the at least one E2 node. The at least one memory and the computer program code may be further configured to, with the at least one processor, cause the apparatus to at least compute at least one optimized per user equipment guidance policy. The at least one memory and the computer program code may be further configured to, with the at least one processor, cause the apparatus to at least transmit the at least one computed optimized per user equipment guidance policy to the at least one E2 node.

In accordance with some embodiments, a non-transitory computer readable medium may be encoded with instructions that may, when executed in hardware, perform a method. The method may include obtaining at least one tier 1 policy. The method may further include obtaining layer 2 (L2) metadata from at least one E2 node. The method may further include obtaining application types run by user equipment served by the at least one E2 node. The method may further include computing at least one optimized per user equipment guidance policy. The method may further include transmitting the at least one computed optimized per user equipment guidance policy to the at least one E2 node.

In accordance with certain embodiments, a computer program product may perform a method. The method may include obtaining at least one tier 1 policy. The method may further include obtaining layer 2 (L2) metadata from at least one E2 node. The method may further include obtaining application types run by user equipment served by the at least one E2 node. The method may further include computing at least one optimized per user equipment guidance policy. The method may further include transmitting the at least one computed optimized per user equipment guidance policy to the at least one E2 node.

In accordance with various embodiments, an apparatus may include circuitry configured to obtain at least one tier 1 policy. The circuitry may further be configured to obtain layer 2 (L2) metadata from at least one E2 node. The circuitry may further be configured to obtain application types run by user equipment served by the at least one E2 node. The circuitry may further be configured to compute at least one optimized per user equipment guidance policy. The circuitry may further be configured to transmit the at least one computed optimized per user equipment guidance policy to the at least one E2 node.

### BRIEF DESCRIPTION OF THE DRAWINGS

For proper understanding of example embodiments, reference should be made to the accompanying drawings, wherein:

FIG. 1 illustrates an example of a signaling diagram according to certain embodiments.

FIG. 2 illustrates an example of a flow diagram of a method according to various embodiments.

FIG. 3 illustrates an example of some novel aspects of network guidance policy generation for DASH video according to some embodiments.

FIG. 4 illustrates an example of a precomputed set of policies corresponding to DASH video resolutions according to certain embodiments.

FIG. 5 illustrates an example of an iterative algorithm for policy computation according to various embodiments.

FIG. 6 illustrates some advantages of dynamic network guidance policies computed by near-RT RIC for DASH video according to some embodiments.

FIG. 7 illustrates some additional advantages of dynamic network guidance policy computed by Near-RT RIC for HD video cases according to certain embodiments.

FIG. 8 illustrates an example of various network devices according to various embodiments.

FIG. 9 illustrates an example of a 5G network and system architecture according to some embodiments.

FIG. 10 illustrates an example of an O-RAN architecture according to certain embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for dynamic policy generation is not intended to limit the scope of certain embodiments, but is instead representative of selected example embodiments.

Many applications, for example, adaptive streaming video, video games, and augmented reality (AR)/virtual reality (VR) are capable of dynamically adjusting their behavior based on current network service conditions, such as throughput, latency, and jitter. During ideal network conditions (e.g., higher available throughput, lower end-to-end latency, etc.), such applications can provide much better quality of experience (QoE) (e.g., high video resolution (full HD, 2K, 4K) video resolution with sharper images, as well as faster and more seamless responses to user actions and external events). During undesirable network conditions (e.g., lower throughput, longer latency, higher jitter), such applications can still function with reduced but still acceptable levels of QoE e.g., lower video resolution (e.g., SD at 480p, 360p, or 240p) with blurrier images and/or longer and less seamless reactions to user actions and events.

Flow network treatment policies can be dynamically generated in near-real-time within the RAN for each UE to optimize application-level spectral efficiency. Such policies for adaptive applications such as those discussed above can optimize spectral resource utilization and achieve selected optimization targets. For example, flow network treatment policies can result in a significantly greater number of UE flows carrying given adaptive application type traffic served with acceptable quality of experience (QoE) while utilizing the same amount of RAN resources. In addition, UE flow network treatment policies may result in effects such as, but not limited to, reducing latency for delay sensitive UE applications, reducing packet loss, reducing jitter. Additionally or alternatively, flow network treatment policies can provide a significantly higher QoE for a larger number of UEs running given adaptive applications using the same amount of RAN resources. O-RAN architecture can provide low latency communications over the E2 interface between a RAN DU, for example a 5G gNB-DU acting as an E2 Node, and a near-real time (Near-RT) RIC, together with the enhanced computer power of near-RT RIC. Any node that connects to a near-RT RIC over the E2 interface can be considered an E2 node in certain embodiments. As a result, certain example embodiments can make it physically possible to use machine learning (ML) techniques to process vast amounts of per UE flow data that can be exposed by the RAN DU over an E2 interface, and compute per in near-RT RIC per UE policies optimized for given utility optimization targets (dictated by network service provider policies). It is noted that existing techniques are not adequate for adaptive applications, where there may be multiple acceptable network policies for the same UE running a specific adaptive application. For example, when the UE attaches, it is too early to compute the network policy which is dependent upon varying UE channel conditions, varying serving cell resource availability, applications that the UE runs, and the status of other UEs running the same application (the latter configured to jointly optimize network policies for all UEs running a given application type (e.g., video) and sharing the same spectral resources. The network policy may govern the way in which the network communicates with the UE, the way the UE communicates with the network, or both.

As will be discussed in more detail below, according to certain embodiments, the term “per UE policy” may refer, for example, to at least two cases: custom policies computed for individual UEs, and/or mapping UEs to one of the pre-defined policies. As an example, policies without UEs assigned may be pre-computed by near-RT RIC, potentially derived from declarative AI policies from the non-RT RIC. One or more UEs may then be assigned to the policies by the near-RT RIC, thereby becoming “per UE.” These policies may be group policies, where n UE are assigned to m group policies; in some cases, m<n, but in other cases where m≥n, it is possible that each UE is assigned to a different policy.

Per serving cell/carrier resource availability/occupancies may also vary dynamically, and may need to be evaluated in near-real time. Per UE channel conditions may change dynamically as a result of UE mobility, varying signal interference from neighboring cells, signal shadowing, channel fading, which also may require reevaluation and recomputation of per UE policies in near real time. Per UE channel conditions may also differ for different cells/carriers when carrier aggregation is used. This data may also vary dynamically, and may need to be assessed in near-real time. MIMO information may be an example of dynamically varying data that may need to be assessed near-real time. Finally, application types may indicate that the UE is running. Additional optimal information may include per UE metadata (e.g., screen size and resolution) that is static in nature, and may impact network policy selection.

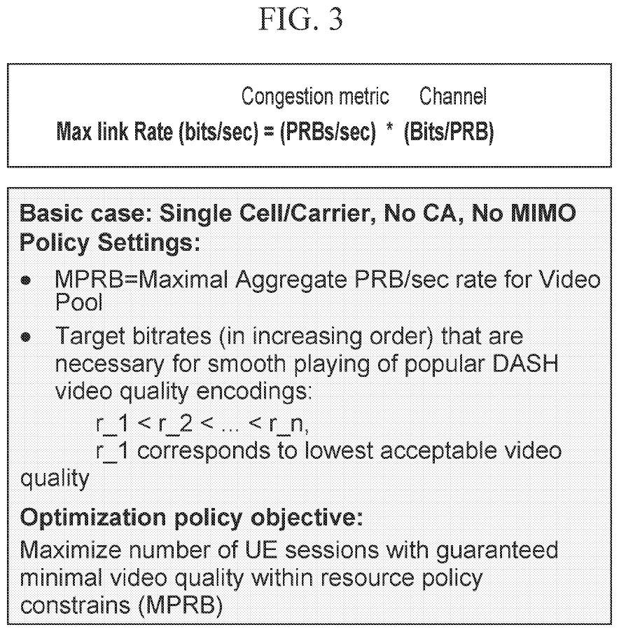

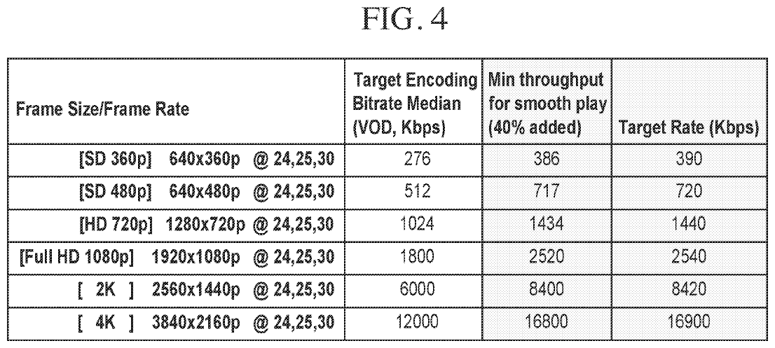

According to an embodiment, per UE network policies (i.e., Tier 2 policies) may be computed from these inputs at near-RT RICs. In certain embodiments, near-RT RICs may receive Tier 1 policies (input 1) from non-RT RICs as AI interface policies at feature initialization time for supporting per UE policy for the given application type. In some embodiments, tier 1 policies may contain parameters configured to compute per UE tier 2 policies. For example, tier 1 policies may include amounts of aggregate spectral resources per cell/sector available to all applications of a given type, and/or tier 2 policies may contain specific maximal throughputs that each UE may obtain at a given cell/sector. In certain embodiments, tier 1 policies may include group policies for unspecified UEs (e.g., different groups may have allowed target throughput rates, as specified in column 4 of FIG. 4), and/or tier 2 policies may be a mapping of individual UEs to a specific group.

A near-RT RIC may receive inputs 2 and 3 in real-time as a continuous stream of E2 reports from a RAN DU. According to one embodiment, a near-RT RIC may identify application types that the UE is running using an ML-based inference based upon idle-burst signatures of end-to-end encrypted application traffic. The near-RT RIC may then compute the per UE network guidance policy by solving an optimization problem (with an optimization objective utility function specified in Tier 1 policy) for resource allocation across all UEs running the same application and sharing the same spectral resources. The near-RT RIC may then perform enforcement of the computed guidance policy by distributing it to relevant serving E2 nodes over an E2 interface.

As will be discussed in more detail below, some example embodiments provide per UE policy generation for adaptive applications in near-RT RIC (as opposed to non-RT RIC). This may allow the near-RT RIC to compute a per UE network policy based upon current UE channel conditions and serving cell congestion levels. In one example, application level spectral efficiency optimization may be performed across one, more or all UEs running the given application types.

Certain embodiments described herein may have various benefits and/or advantages to overcome at least the disadvantages described above, as well as other problems that might not be explicitly discussed herein. For example, certain embodiments may allow for a significantly higher number of video UEs served by the same amount of spectral resources, as well as allow video UEs to have significantly higher QoE under congestion (e.g., full HD and 2K video instead of SD). Thus, certain embodiments discussed below are directed to improvements in computer-related technology.

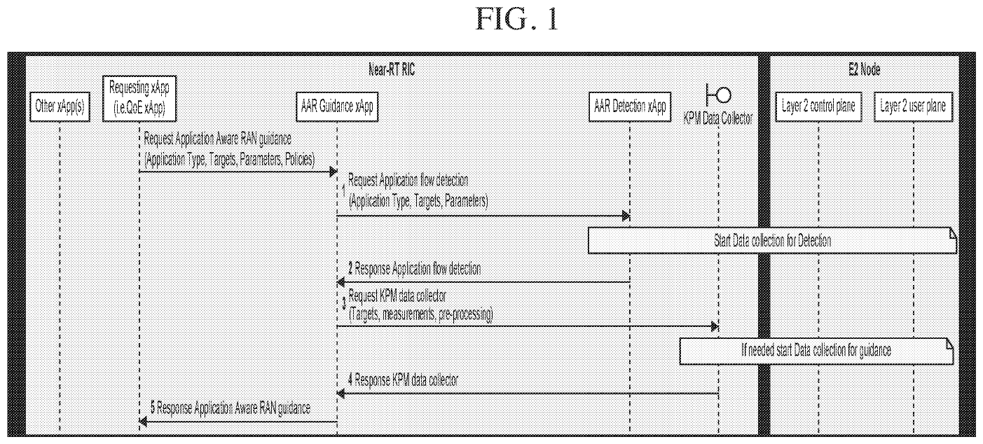

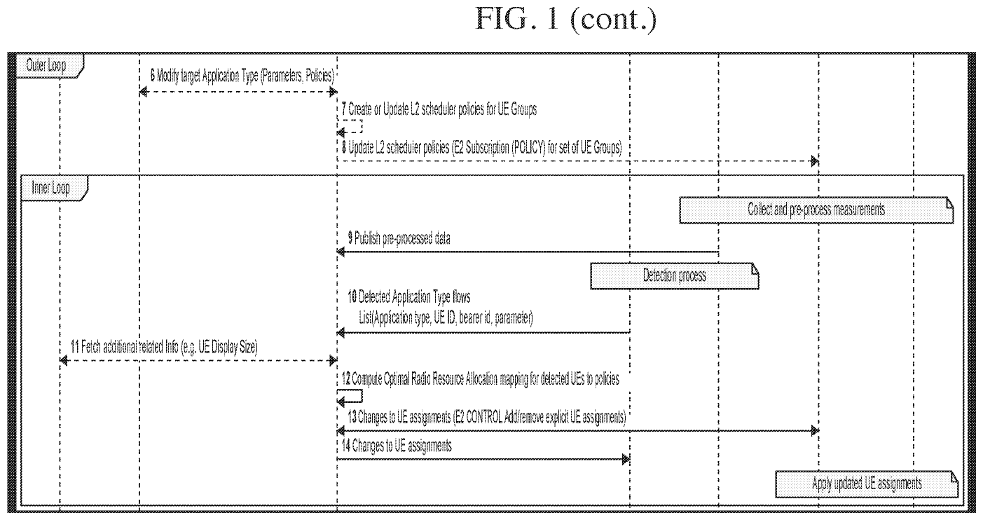

FIG. 1 illustrates an example of a signaling diagram depicting radio resource allocation guidance policy generation for target application types, according to one embodiment. Specifically, some embodiments may generate guidance for radio resource allocation and/or QoS parameters (e.g., target bitrates, priorities, etc.) for UE radio bearers carrying target application type to optimize QoE, and increase application level spectral efficiency for target application types. The example of FIG. 1 illustrates a near-RT RIC, which may comprise a KPM data collector, AAR detection xApp, guidance xApp, requesting xAPP, and other xApps.

In various embodiments, the AAR detection application may support identifying UEs carrying traffic of target application type. In addition, the KPM data collector and E2 node may support required measurements, pre-processing, and sampling rate. Furthermore, the AAR guidance xApp may host appropriate guidance computation algorithms for the UE and radio bearer resource allocation for target application type; this may create or update one or more guidance policies, and/or assign respective UEs and bearers to the appropriate “AAR behavior class” based upon UE channel conditions and serving cell congestion levels. The RAN may support guidance policy settings with assignments to the UE via a definition of UE groups based on a set of selection criteria, such as slice and QoS parameters, and an AAR behavior class “tag” inserted into the UE context. The AAR detection xApp may be configured to identify target application type, and may have an appropriate ML model installed. Furthermore, the E2 node may support required policy groups based on UE context “tags.” Initially, the AAR guidance xApp may receive a request to start guidance for target application type, target UE classes, and flow type.

As illustrated in the example of FIG. 1, at 1, the application aware radio access network (AAR) guidance xApp may send a request to the AAR detection xApp to start application type detection for target Application Type, UE target, and parameters such as slice and bearer type. The AAR Detector may then initiate KPM measurement reporting for detection. At 2, the AAR Detector xApp may respond to the AAR Guidance that the detection process has started.

As illustrated in the example of FIG. 1, at 3, the AAR guidance xApp may request the KPM data collector to collect target UE target parameters such as slice and bearer type, and perform required pre-processing. In various embodiments, the KPM data collector may issue E2 subscriptions to a Layer 2 user plane (if not currently collecting required measurements). At 4, the KPM data collector may indicate to the AAR guidance that data collection has started. At 5, the AAR guidance xApp may respond to the requesting xApp that the guidance process has started. Optionally, at 6, the requestor xApp may send an update to the AAR guidance xApp configured to modify any of target application type, target UE class, and flow type.

As illustrated in the example of FIG. 1, at 7, the AAR guidance xApp may compare recent guidance performance with targets set by the Requesting xApp; adjust UE group definitions (i.e., a list of criteria configured to map the UE into UE groups including AAR behavior class); and/or calculate a set of group policies for an O-DU RAN layer 2 scheduler with discrete target rates optimized for target application type.

As illustrated in the example of FIG. 1, at 8, the AAR guidance xApp may send updated policies to the E2 node. At 9, KPM data collector may collect and pre-process L2 meta-data, and may publish the pre-processed data to both the AAR detection and AAR guidance xApps. At 10, the AAR detection xApp may perform an application type detection process using the KPM published data and, if one or more UE are detected, transmit to the AAR guidance xApp a list of detected UE (application Type; UE ID; and radio bearer identifier, and optionally, estimates of application type specific parameters). Furthermore, at 11, the AAR Guidance xApp may optionally fetch additional related info from other xApps (e.g., UE display size).

As illustrated in the example of FIG. 1, at 12, the AAR guidance xApp may compute optimal radio resource allocation for the identified UE according to target application type, and the detection xApp may estimate and map the UEs to an optimal AAR behavior class. At 13, the AAR guidance xApp sends to the E2 any changes to the assignment of UE context “tags” used to set AAR behavior class. At 14, the AAR guidance xApp informs the AAR Detection xApp of resource allocation policies (e.g., target rates or rate caps set), and information on assignment of specific UE.

The AAR guidance xApp may then receive a request to stop handling target application types. In response, the AAR Guidance xApp may delete subscriptions to one or more required KPM data collector flows associated with certain target flow types, UE groups, etc. Additionally or alternatively, the AAR guidance xApp may delete detection requests on the AAR detection xApp. AAR Guidance xApp responds to Requestor that guidance process has stopped for target application type.

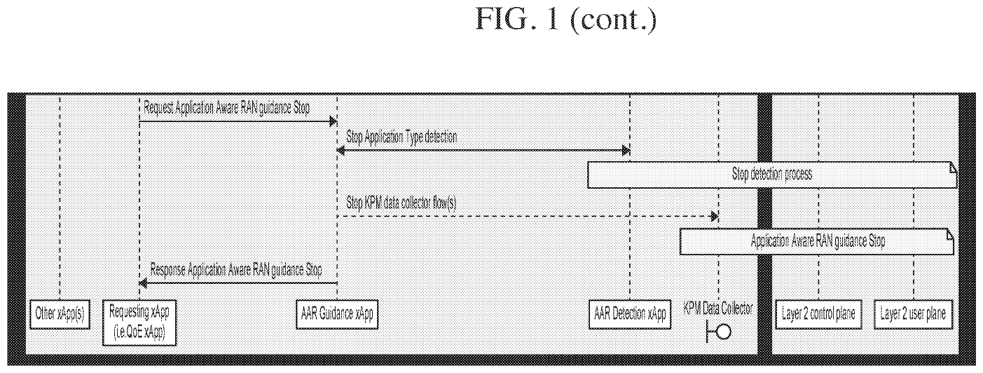

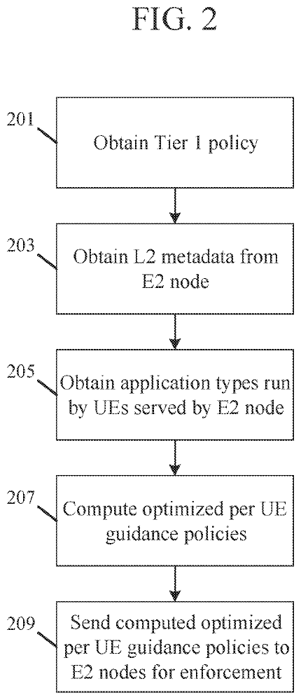

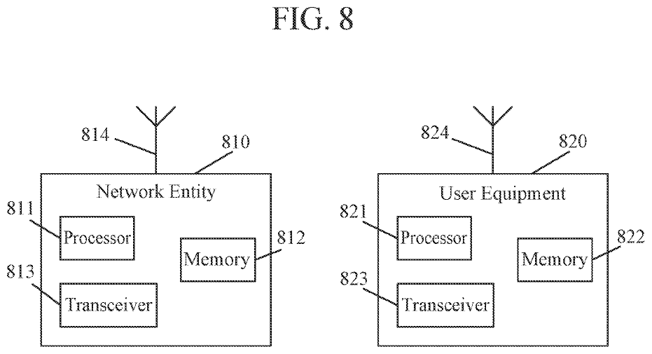

FIG. 2 illustrates an example of a flow diagram of a method for dynamic policy generation, according to an example embodiment. For example, one objective of the method depicted in the example of FIG. 2 may include computing or determining a network policy that is optimized across the UEs running an application and/or sharing the same spectral resources. In certain embodiments, the method of FIG. 2 may be performed by a Near-RT RIC, such as NE 810 illustrated in FIG. 8 discussed below.

As illustrated in the example of FIG. 2, at 201, the Near-RT RIC may obtain a tier 1 policy, for example, from an operations administration and management (OAM) and/or non-RT RIC over an AI interface and/or initialization of feature support for a specific application type. Specifically, a tier 1 policy may contain a set of generic policy parameters configured to compute individual per UE policies. For example, tier 1 policies may include a maximal aggregate amount of spectral resources P configured to be used at a given cell/carrier for all UEs running specific application type.

If there is a network service slice configured for UEs running a given application type, the policy parameters may indicate a maximal aggregate amount of spectral resources (e.g., PRBs/sec) that may be allocated to UE flows on the network slice in a given cell carrier. This policy parameter may vary from cell to cell, and may be different across different applications. For a specific cell/carrier and application type, this policy parameter may depend upon a number of simultaneous application sessions served by the cell, time-of-day, and resource needs by UEs running other application types and served by this cell/carrier, for example, according to P[cellId]=f(appType,numberOfAppSessions,TimeOfDay,OtherAppFlowsNeeds. In addition, step 201 may be performed periodically (e.g., every 1 hour), or any time Tier 1 policy changes, while steps 203-209 (per UE policy computation by Near-RT RIC) may be performed periodically (e.g., every 1-2 seconds).

As another example, tier 1 policies may include per application type set of network policies that can result in acceptable performance once adaptive application adapts to the policy selected from this set. Selection of the specific network policy for the given UE depends upon dynamic factors as discussed later and is generally performed via optimization across multiple UEs running the same application type. For example, better network conditions may allow to select less restrictive policy, e.g., higher allowed maximal throughput, lower average latency, etc. In addition, worse UE channels, fewer available cell resources, larger number of simultaneous application sessions served by the same cell may result in necessity to select more restrictive policies, e.g., lower allowed maximal throughput, higher average latency, etc. For example, for DASH video applications, such a set of network policies may include a set of target rates based upon known mappings of average throughout rates (including overhead for smooth playing) to video encodings at particular resolutions, for example, “SD 360p 30 fps”: 390 Kbps, “SD 480p 30 fps”: 720 Kbps, “HD 720p 30 fps”: 1440 Kbps, “FullHD 1080p 30 fps”: 2540 Kbps, “2K 1440p 30 fps”: 8420 Kbps, “4K 2160p 30 fps”: 16900 Kbps.

As yet another example, tier 1 policies may include per application type joint optimization objectives for resource distribution across UEs running applications of same types and sharing spectral resources. For example, for DASH video, such optimization objectives may include any of a maximize number of UEs with satisfactory QoE with video resolution SD 480p or better; a maximize number of UEs with satisfactory QoE with video resolution HD 720p; and a maximize number of UEs with satisfactory QoE with video resolution Full HD 1080p.

As yet another example, a Tier 1 policy may include group policies for unspecified UEs (e.g., different groups may have allowed target throughput rates specified as in column 4 of FIG. 4), and a Tier 2 policy may be a mapping of individual UE to a specific group.

As further illustrated in the example of FIG. 2, at 203, the Near-RT RIC may obtain L2 metadata from an E2 node. For example, the Near-RT RIC may receive data in the form of periodic reports from E2 nodes every T=[1 . . . 2] seconds. It may include Per UE data, such as per cell/carrier Scheduler data (e.g., allocated PRBs, successfully transmitted bits of data); per UE RLC data (e.g., sequence of averaged over t1=[10 msec . . . 50 msec] RLC buffer fullness); list of cell carriers serving the given UE; MIMO rank of the UE; and 5QI and slice membership. The L2 metadata may also include be aggregate per slice and 5QI (available PRBs, allocated PRBs).

As illustrated in the example of FIG. 2, at 205, the Near-RT RIC may obtain application types run by UEs served by the E2 node. For example, the Near-RT RIC may identify application type that the UE is running using Machine Learning (ML) based inference using pre-trained ML models based upon idle-burst signatures of End-To-End encrypted application traffic. The Near-RT RIC may receive information on application types that the UE is running from other sources.

As illustrated in the example of FIG. 2, at 207, the Near-RT RIC may compute optimized per UE guidance policies. In some embodiments, the per UE guidance policies may be computed using the data from steps 201-205. The near-RT RIC may compute per UE network guidance policies by solving an optimization problem (with an optimization objective utility function specified in Tier 1 policy) for resource allocation across all UEs running the same application and sharing the same spectral resources.

As illustrated in the example of FIG. 2, at 209, the Near-RT RIC may send computed optimized per UE guidance policies to E2 nodes for enforcement, as discussed above. The provision of the policies to the E2 nodes may result in the E2 nodes operating according to the policies. New flow network treatment policies applied at E2 nodes can provide a significantly greater number of UE flows carrying given adaptive application type traffic served with acceptable quality of experience (QoE) while utilizing the same amount of RAN resources. Additionally or alternatively, applied flow network treatment policies can result in significantly higher QoE for a larger number of UEs running given adaptive applications while utilizing the same amount of RAN resources. This higher QoE may be a result of the policy providing optimal wireless channel throughput for one or more UEs, lower latency and jitter, reduced packet loss.

FIG. 3 illustrates an example of some novel aspects of network guidance policy generation for DASH video. Specifically, the top formula includes congestion metrics that may be computed as a number of physical resource blocks (PRBs) per seconds that maybe available to an idealistic “very active” UE flow (i.e., the flow always has data to transmit). The formula also includes a channel metric that may be computed as a ratio of number of allocated PRBs per second to a flow to a number of bits per second successfully transmitted. Furthermore, video rates r₁, r₂ . . . rₙ may be defined by tier 1 policies, as shown in column 4 of FIG. 4.

FIG. 4 illustrates an example of a precomputed set of policies corresponding to DASH video resolutions. In particular, the second column provides typical throughput rates needed to sustain associated resolutions in the first column. The third column adds an additional 40% throughput to ensure smooth playback, and the fourth column provides precomputed group target rate policies. It is noted that FIG. 4 is provided as one example. Other examples are possible according to certain embodiments.

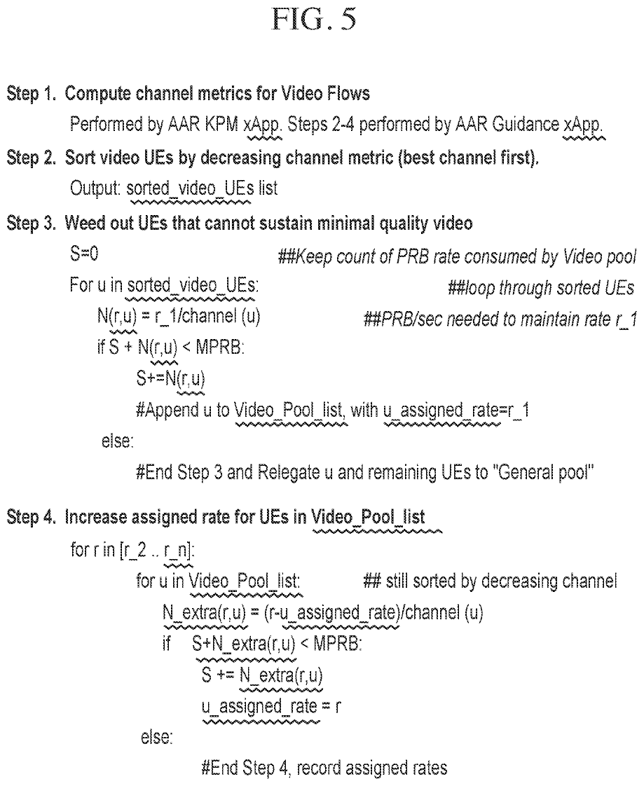

FIG. 5 illustrates an example of an iterative algorithm or method for policy computation. The algorithm may enable an increased assigned rate for UEs. As illustrated in the example of FIG. 5, the method may include computing channel metrics for video flows, sorting video UEs by decreasing channel metric, identifying and removing UEs that cannot sustain minimal quality video, and increasing the assigned rate for UEs in the video pool list.

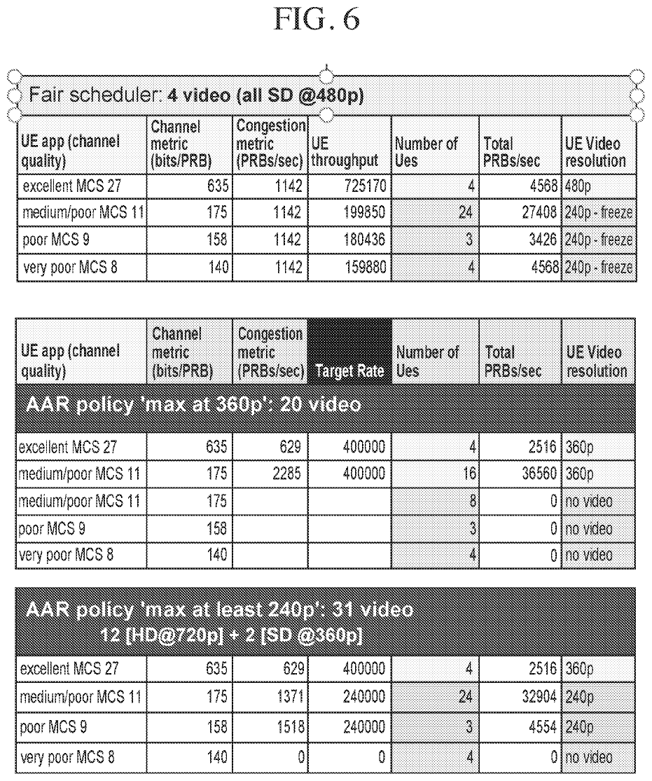

FIG. 6 illustrates some advantages of dynamic network guidance policies computed by near-RT RIC for DASH video, according to some embodiments; for example, SD video use may be improved with up to 7× more UEs having acceptable video quality using the same amount of radio resources. It is noted that FIG. 6 is provided as one example. Other examples are possible according to certain embodiments.

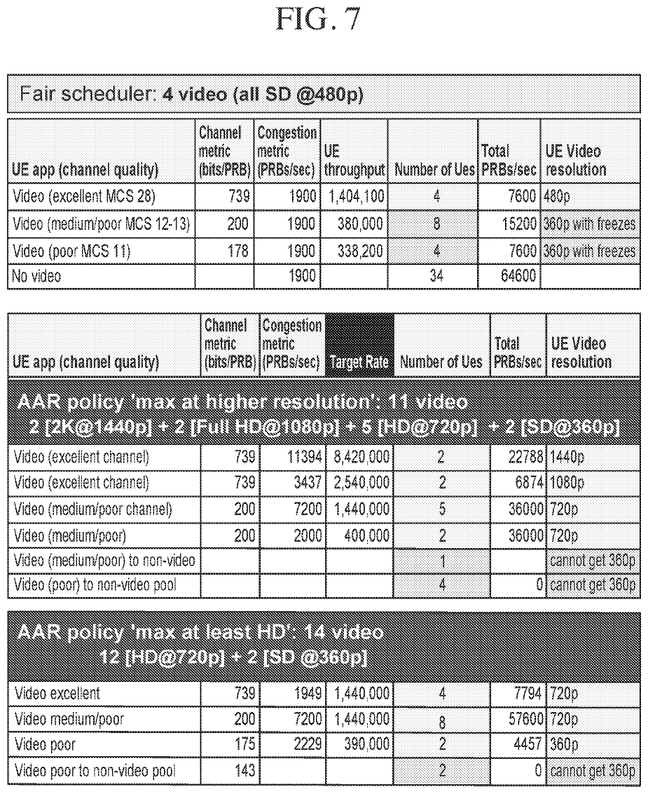

FIG. 7 illustrates some additional advantages of dynamic network guidance policy computed by Near-RT RIC for HD video cases. Specifically, HD and even 2K video may be possible where only SD video was previously possible. It is noted that FIG. 7 is provided as one example. Other examples are possible according to certain embodiments.

FIG. 8 illustrates an example of a system according to certain example embodiments. In one example embodiment, a system may include multiple devices, such as, for example, NE 810 and/or UE 820.

NE 810 may be one or more of a base station, such as an eNB or gNB, a serving gateway, a server, and/or any other access node or combination thereof. Furthermore, NE 810 and/or UE 820 may be one or more of a citizens broadband radio service device (CBSD).

NE 810 may further comprise at least one gNB-CU, which may be associated with at least one gNB-DU. The at least one gNB-CU and the at least one gNB-DU may be in communication via at least one F1 interface, at least one Xn-C interface, and/or at least one NG interface via a 5GC.

NE 810 may further comprise at least one gNB which is associated with at least one Near-RT RIC. The at least one Near-RT RIC and the at least one gNB acting as an E2 Node may be in communication via at least one E2 interface. The at least one Near-RT RIC may be in communication via at least E2 interface with at least one gNB-CU and at least one gNB-DU where each gNB-CU and gNB-DU acts as an E2 Node.

UE 820 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

NE 810 and/or UE 820 may include at least one processor, respectively indicated as 811 and 821. Processors 811 and 821 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 812 and 822. The memory may be fixed or removable. The memory may include computer program instructions or computer code contained therein. Memories 812 and 822 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 811 and 821, memories 812 and 822, and any subset thereof, may be configured to provide means corresponding to the various blocks of FIGS. 1-2. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 8, transceivers 813 and 823 may be provided, and one or more devices may also include at least one antenna, respectively illustrated as 814 and 824. The device may have many antennas, such as an array of antennas configured for multiple input multiple output (MIMO) communications, or multiple antennas for multiple RATs. Other configurations of these devices, for example, may be provided. Transceivers 813 and 823 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1-2). Therefore, in certain embodiments, a non-transitory computer-readable medium may be encoded with computer instructions that, when executed in hardware, perform a process such as one of the processes described herein. Alternatively, certain embodiments may be performed entirely in hardware.

In certain embodiments, an apparatus may include circuitry configured to perform any of the processes or functions illustrated in FIGS. 1-2. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

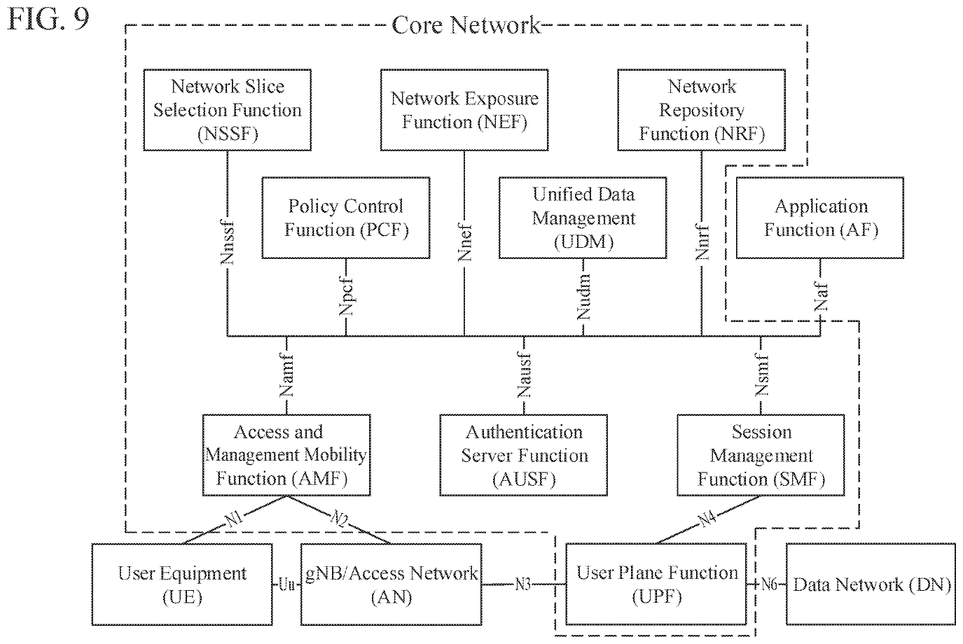

FIG. 9 illustrates an example of a 5G network and system architecture according to certain embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 9 may be similar to NE 810 and UE 820, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

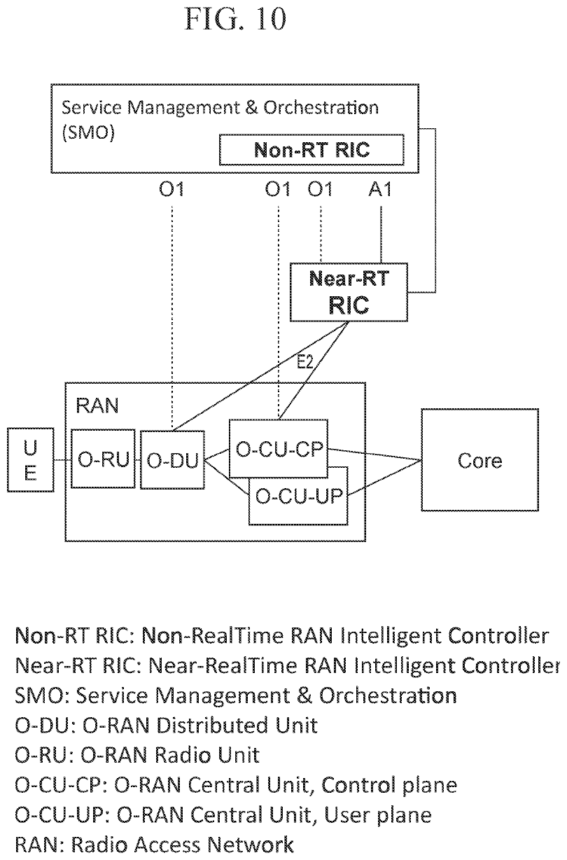

FIG. 10 illustrates an example of an O-RAN architecture according to certain embodiments. Shown are multiple network functions, O-DU, O-CU-CP and O-CU-UP, all acting as an E2 Node, in communications with the Near-RT RIC via the E2 interface. The Near-RT RIC may contain one or more applications, known as xApps, used to provide near-realtime RAN optimization services.

Other embodiments are also possible including a 5G gNB acting as an E2 Node providing E2 services for the O-UD, O-CU-CP and O-CU-UP functions, or the logical Near-RT RIC and gNB-CU-CP or gNB are deployed together and the functions of the Near-RT RIC may be integrated into the gNB.

The E2 interface may be used to collect data from the E2 Node using E2 Reports, may be used to install in the E2 Node one or more E2 Policies and may be used to install or remove in the E2 Node one or more UE specific “tags” using E2 Control messages.

At least one Near-RT RIC may also communicate with the Non-RT RIC via the AI interface. The AI interface may be used to install one or more AI policies in the Near-RT RIC.

### Partial Glossary

3GPP Third Generation Partnership Project
5G Fifth Generation
5GC Fifth Generation Core
5GS Fifth Generation System
5QI Fifth Generation Quality of Service Indicator
AAR Application Aware Radio Access Network
ASIC Application Specific Integrated Circuit
CA Carrier Aggregation
CBSD Citizens Broadband Radio Service Device
CN Core Network
CPU Central Processing Unit
DASH Dynamic Adaptive Streaming over HTTP
DL Downlink
DU Distributed Unit
eMBB Enhanced Mobile Broadband
eNB Evolved Node B
FpS Frames per Second
gNB Next Generation Node B
GPS Global Positioning System
HD High Definition
HDD Hard Disk Drive
IoT Internet of Things
KPM Key Performance Measurement
L2 Layer 2
LTE Long-Term Evolution
LTE-A Long-Term Evolution Advanced
MBS Multicast and Broadcast Systems
MC Multicast
MCS Modulation and Coding Scheme
MEMS Micro Electrical Mechanical System
MIMO Multiple Input Multiple Output
ML Machine Learning
mMTC Massive Machine Type Communication
MTC Machine Type Communication
NB-IoT Narrowband Internet of Things
Near-RT RIC Near-RealTime RIC
Non-RT RIC Non-RealTime RIC
NE Network Entity
NG Next Generation
NR New Radio
O-CU-CP O-RAN Central Unit, Control plane
O-CU-UP O-RAN Central Unit, User plane
O-DU O-RAN Distributed Unit
O-RU O-RAN Radio Unit
O-RAN Open Radio Access Network
PDA Personal Digital Assistance
PRB Physical Resource Block
QoE Quality of Experience
QoS Quality of Service
RAM Random Access Memory
RAN Radio Access Network
RAT Radio Access Technology
RIC Radio Access Network Intelligent Controller
RLC Radio Link Control
RRC Radio Resource Control
RT Real Time
SD Standard Definition
SMO Service Management & Orchestration
UE User Equipment
UMTS Universal Mobile Telecommunications System
UPF User Plane Function
URLLC Ultra-Reliable and Low-Latency Communication
UTRAN Universal Mobile Telecommunications System Terrestrial Radio Access Network
WG Working Group

According to certain embodiments, an apparatus can include at least one processor and at least one memory storing instructions that, when executed by the at least one processor, cause the apparatus at least to obtain at least one tier 1 policy, obtain layer 2 (L2) metadata from at least one E2 node, obtain application types run by user equipment served by the at least one E2 node, compute at least one optimized per user equipment guidance policy based on the at least one tier 1 policy, the L2 metadata, and the applications types, and transmit the at least one computed optimized per user equipment guidance policy to the at least one E2 node.

In certain embodiments, the per user equipment guidance policy can include at least one of a custom policy computed for an individual user equipment or at least one mapping of user equipment to at least one of the predefined group policies.

In certain embodiments, the obtaining of the at least one tier 1 policy can include obtaining the at least one tier 1 policy periodically or when the at least one tier 1 policy changes.

In certain embodiments, the computing of the per user equipment guidance policy can include calculating at least one assignment of individual user equipment to one or more of the predefined group policies.

In certain embodiments, the transmitting of the at least one computed optimized per user equipment guidance policy can include transmitting the at least one set of L2 group policies to the E2 node.

In certain embodiments, the at least one tier 1 policy can include at least one set of generic policy parameters configured to compute individual per user equipment policies.

In certain embodiments, the at least one tier 1 policy can include at least one maximal aggregate amount of spectral resources configured to be used at a given cell for all user equipment running at least one specific application type.

In certain embodiments, the at least one tier 1 policy can include at least one group policy.

In certain embodiments, the L2 metadata can include at least one of: per cell/carrier scheduler data; per user equipment radio link control data; at least one list of cell carriers serving at least one given user equipment; multiple-input multiple-output rank of at least one given user equipment; fifth generation i membership; or network slice membership.

In certain embodiments, the obtaining of application types can include identifying at least one application type that the user equipment served by the at least one E2 node is running using machine learning-based inference according to at least one pre-trained machine learning model based upon idle-burst signatures of end-to-end encrypted application traffic.

In certain embodiments, the computing at least one optimized per user equipment guidance policy can include computing at least one per user equipment network guidance policy according to at least one optimization problem.

In certain embodiments, the at least one memory and the computer program code can be further configured to, with the at least one processor, cause the apparatus at least to assign at least one individual user equipment to at least one group policy.

In certain embodiments, the apparatus further can include one or more of: at least one requesting xApp; at least one Application Aware Radio Access Network (AAR) guidance xApp; at least one AAR detection xApp; or at least one key performance measurement (KPM) data collector.

In certain embodiments, the at least one memory and the computer program code can be further configured to, with the at least one processor, cause the apparatus at least to receive at least one request to start guidance for application aware RAN guidance from the at least one requesting xApp.

In certain embodiments, the request to start guidance for application aware RAN guidance is associated with one or more of application type, targets, parameters, or policies.

In certain embodiments, the at least one memory and the computer program code can be further configured to, with the at least one processor, cause the apparatus at least to receive at least one request to start application type detection associated with at least one of application type, slice type, or bearer type.

In certain embodiments, the at least one memory and the computer program code can be further configured to, with the at least one processor, cause the apparatus at least to initiate KPM measurement reporting for detection.

In certain embodiments, the at least one memory and the computer program code can be further configured to, with the at least one processor, cause the apparatus at least to receive at least one indication that application type detection has started.

In certain embodiments, the at least one memory and the computer program code can be further configured to, with the at least one processor, cause the apparatus at least to receive at least one request for KPM data collection for target slice type, bearer type, and required pre-processing.

In certain embodiments, the at least one memory and the computer program code can be further configured to, with the at least one processor, cause the apparatus at least to transmit at least one E2 subscription to at least one L2 user plane when the KPM data collector is not collecting required measurements.

In certain embodiments, the at least one memory and the computer program code can be further configured to, with the at least one processor, cause the apparatus at least to transmit at least one indication that data collection has started.

In certain embodiments, the at least one memory and the computer program code can be further configured to, with the at least one processor, cause the apparatus at least to transmit at least one indication that the application type detection has started.

In certain embodiments, the at least one memory and the computer program code can be further configured to, with the at least one processor, cause the apparatus at least to exchange updated guidance configured to modify one or more of application type, target UE class, or flow type.

In certain embodiments, the at least one AAR guidance xApp of the apparatus can perform comparing recent guidance performance against at least one target set; and based on the comparing, adjusting at least one group definition.

In certain embodiments, the at least one memory and the computer program code are further configured to, with the at least one processor, cause the apparatus at least to transmit, to the E2 node, at least one updated L2 group policy.

In certain embodiments, the at least one memory and the computer program code can be further configured to, with the at least one processor, cause the apparatus at least to collect and process, by the at least one KPM data collector of the apparatus, L2 metadata.

In certain embodiments, the at least one memory and the computer program code can be further configured to, with the at least one processor, cause the apparatus at least to transmit, by the at least one KPM data collector to at least one of the at least one AAR guidance xApp or the at least one AAR detection xApp of the apparatus, the processed L2 metadata.

In certain embodiments, the at least one memory and the computer program code can be further configured to, with the at least one processor, cause the apparatus at least to perform, by the at least one AAR detection xApp of the apparatus, application type detection based upon the processed L2 metadata.

In certain embodiments, the at least one memory and the computer program code can be further configured to, with the at least one processor, cause the apparatus at least to receive, by the at least one AAR guidance xApp of the apparatus, information associated with the at least one other xApp.

In certain embodiments, the at least one memory and the computer program code can be further configured to, with the at least one processor, cause the apparatus at least to compute, by the at least one AAR guidance xApp of the apparatus, optimal radio resource allocation associated with at least one user equipment based upon target application type; and estimate and map, by the at least one AAR detection xAPP of the apparatus, the user equipment to at least one optimal AAR behavior class.

In certain embodiments, the at least one memory and the computer program code can be further configured to, with the at least one processor, cause the apparatus at least to transmit, to the at least one O-DU, at least one user equipment assignment context tag change.

In certain embodiments, the at least one memory and the computer program code can be further configured to, with the at least one processor, cause the apparatus at least to transmit, by the at least one AAR guidance xAPP to at least one AAR detection xApp of the apparatus, at least one resource allocation policy indication and information associated with specific user equipment assignment.

According to certain embodiments, an apparatus can include means for obtaining at least one tier 1 policy; means for obtaining layer 2 (L2) metadata from at least one E2 node; means for obtaining application types run by user equipment served by the at least one E2 node; means for computing at least one optimized per user equipment guidance policy based on the at least one tier 1 policy, the L2 metadata, and the applications types; and means for transmitting the at least one computed optimized per user equipment guidance policy to the at least one E2 node.

In certain embodiments, the per user equipment guidance policy can include at least one of a custom policy computed for an individual user equipment or at least one mapping of user equipment to at least one of the predefined group policies.

In certain embodiments, the obtaining of the at least one tier 1 policy can include obtaining the at least one tier 1 policy periodically or when the at least one tier 1 policy changes.

In certain embodiments, the computing of the per user equipment guidance policy can include calculating at least one assignment of individual user equipment to one or more of the predefined group policies.

In certain embodiments, the transmitting of the at least one computed optimized per user equipment guidance policy can include transmitting the at least one set of L2 group policies to the E2 node.

In certain embodiments, the at least one tier 1 policy can include at least one set of generic policy parameters configured to compute individual per user equipment policies.

In certain embodiments, the at least one tier 1 policy can include at least one maximal aggregate amount of spectral resources configured to be used at a given cell for all user equipment running at least one specific application type.

In certain embodiments, the at least one tier 1 policy can include at least one group policy.

In certain embodiments, the L2 metadata can include at least one of: per cell/carrier scheduler data; per user equipment radio link control data; at least one list of cell carriers serving at least one given user equipment; multiple-input multiple-output rank of at least one given user equipment; fifth generation i membership; or network slice membership.

In certain embodiments, the obtaining of application types can include identifying at least one application type that the user equipment served by the at least one E2 node is running using machine learning-based inference according to at least one pre-trained machine learning model based upon idle-burst signatures of end-to-end encrypted application traffic.

In certain embodiments, the computing at least one optimized per user equipment guidance policy can include computing at least one per user equipment network guidance policy according to at least one optimization problem.

In certain embodiments, the apparatus can further include means for assigning at least one individual user equipment to at least one group policy.

In certain embodiments, the apparatus can further include one or more of: means for at least one requesting xApp; means for at least one Application Aware Radio Access Network (AAR) guidance xApp; means for at least one AAR detection xApp; or means for at least one key performance measurement (KPM) data collector.

In certain embodiments, the apparatus can further include means for receiving at least one request to start guidance for application aware RAN guidance from the at least one requesting xApp.

In certain embodiments, the request to start guidance for application aware RAN guidance is associated with one or more of application type, targets, parameters, or policies.

In certain embodiments, the apparatus can further include means for receiving at least one request to start application type detection associated with at least one of application type, slice type, or bearer type.

In certain embodiments, the apparatus can further include means for initiating KPM measurement reporting for detection.

In certain embodiments, the apparatus can further include means for receiving at least one indication that application type detection has started.

In certain embodiments, the apparatus can further include means for receiving at least one request for KPM data collection for target slice type, bearer type, and required pre-processing.

In certain embodiments, the apparatus can further include means for transmitting at least one E2 subscription to at least one L2 user plane when the KPM data collector is not collecting required measurements.

In certain embodiments, the apparatus can further include means for transmitting at least one indication that data collection has started.

In certain embodiments, the apparatus can further include means for transmitting at least one indication that the application type detection has started.

In certain embodiments, the apparatus can further include means for exchanging updated guidance configured to modify one or more of application type, target UE class, or flow type.

In certain embodiments, the apparatus can further include means for at least one AAR guidance xApp performing: comparing recent guidance performance against at least one target set; or based on the comparing, adjusting at least one group definition.

In certain embodiments, the apparatus can further include means for transmitting at least one updated L2 group policy.

In certain embodiments, the apparatus can further include means for collecting and processing L2 metadata.

In certain embodiments, the apparatus can further include means for transmitting the processed L2 metadata.

In certain embodiments, the apparatus can further include means for performing application type detection based upon the processed L2 metadata.

In certain embodiments, the apparatus can further include means for receiving information associated with the at least one other xApp.

In certain embodiments, the apparatus can further include means for computing optimal radio resource allocation associated with at least one user equipment based upon target application type; and means for estimating and mapping the user equipment to at least one optimal AAR behavior class.

In certain embodiments, the apparatus can further include means for transmitting at least one user equipment assignment context tag change.

In certain embodiments, the apparatus can further include means for transmitting at least one resource allocation policy indication and information associated with specific user equipment assignment.

1. A method, comprising:
obtaining, with a near-real-time radio access node intelligent controller, at least one tier 1 policy;
obtaining, with the near-real-time radio access node intelligent controller, layer 2 metadata from at least one E2 node;
obtaining, with the near-real-time radio access node intelligent controller, application types run with user equipment served with the at least one E2 node;
computing, with the near-real-time radio access node intelligent controller, at least one optimized per user equipment guidance policy based on the at least one tier 1 policy, the layer 2 metadata, and the applications types; and
transmitting, with the near-real-time radio access node intelligent controller, the at least one computed optimized per user equipment guidance policy to the at least one E2 node.

2-32. (canceled)

33. An apparatus, comprising:
at least one processor; and
at least one non-transitory memory storing instructions that, when executed with the at least one processor, cause the apparatus at least to:
obtain at least one tier 1 policy;
obtain layer 2 metadata from at least one E2 node;
obtain application types run with user equipment served with the at least one E2 node;
compute at least one optimized per user equipment guidance policy based on the at least one tier 1 policy, the layer 2 metadata, and the applications types; and
transmit the at least one computed optimized per user equipment guidance policy to the at least one E2 node.

34-36. (canceled)

37. The apparatus of claim 33, wherein the per user equipment guidance policy comprises at least one of a custom policy computed for an individual user equipment or at least one mapping of user equipment to at least one of the predefined group policies.

38. The apparatus of claim 33, wherein the instructions, when executed with the at least one processor, cause the apparatus to obtain the at least one tier 1 policy periodically or when the at least one tier 1 policy changes.

39. The apparatus of claim 33, wherein the instructions, when executed with the at least one processor, cause the apparatus to calculate, with the near-real-time radio access node intelligent controller, at least one assignment of individual user equipment to one or more of the predefined group policies.

40. The apparatus of claim 33, wherein the instructions, when executed with the at least one processor, cause the apparatus to transmit, with the near-real-time radio access node intelligent controller, the at least one set of layer 2 group policies to the E2 node.

41. The apparatus of claim 33, wherein the at least one tier 1 policy comprises at least one set of generic policy parameters configured to compute individual per user equipment policies.

42. The apparatus of claim 33, wherein the at least one tier 1 policy comprises at least one maximal aggregate amount of spectral resources configured to be used at a given cell for user equipment running at least one specific application type.

43. The apparatus of claim 33, wherein the at least one tier 1 policy comprises at least one group policy.

44. The apparatus of claim 33, wherein the layer 2 metadata comprises at least one of:
per cell/carrier scheduler data;
per user equipment radio link control data;
at least one list of cell carriers serving at least one given user equipment;
multiple-input multiple-output rank of at least one given user equipment;
fifth generation i membership; or
network slice membership.

45. The apparatus of claim 33, wherein the instructions, when executed with the at least one processor, cause the apparatus to identify, with the near-real-time radio access node intelligent controller, at least one application type that the user equipment served with the at least one E2 node is running using machine learning-based inference according to at least one pre-trained machine learning model based upon idle-burst signatures of end-to-end encrypted application traffic.

46. The apparatus of claim 33, wherein the instructions, when executed with the at least one processor, cause the apparatus to compute, with the near-real-time radio access node intelligent controller, at least one per user equipment network guidance policy according to at least one optimization problem.

47. The apparatus of claim 33, wherein the instructions, when executed with the at least one processor, cause the apparatus to assign, with the near-real-time radio access node intelligent controller, at least one individual user equipment to at least one group policy.

48. The apparatus of claim 33, wherein the near-real-time radio access node intelligent controller comprises one or more of:
at least one requesting xApp;
at least one application aware radio access network guidance xApp;
at least one application aware radio access network detection xApp; or
at least one key performance measurement data collector.

49. The apparatus of claim 33, wherein the instructions, when executed with the at least one processor, cause the apparatus to receive, at the at least one application aware radio access network guidance xApp of the near-real-time radio access node intelligent controller, at least one request to start guidance for application aware radio access network guidance from the at least one requesting xApp.

50. The apparatus of claim 33, wherein the request to start guidance for application aware radio access network guidance is associated with one or more of application type, targets, parameters, or policies.

51. The apparatus of claim 33, wherein the instructions, when executed with the at least one processor, cause the apparatus to receive, with the application aware radio access network detection xApp of the near-real-time radio access node intelligent controller, at least one request to start application type detection associated with at least one of application type, slice type, or bearer type.

52. The apparatus of claim 33, wherein the instructions, when executed with the at least one processor, cause the apparatus to initiate, with the application aware radio access network detection xApp of the near-real-time radio access node intelligent controller, key performance measurement reporting for detection.

53. The apparatus of claim 33, wherein the instructions, when executed with the at least one processor, cause the apparatus to receive, with the application aware radio access network guidance xApp of the near-real-time radio access node intelligent controller, at least one indication that application type detection has started.

54. The apparatus of claim 33, wherein the instructions, when executed with the at least one processor, cause the apparatus to receive, with the key performance measurement data collector of the near-real-time radio access node intelligent controller, at least one request for key performance measurement data collection for target slice type, bearer type, and required pre-processing.
